(19) United States
(12) Patent Application Publication
(10) Pub. No.: US 2004/0149842 A1
(43) Pub. Date: Aug. 5, 2004

(54) Hammermill with improved comminuting efficiency

(76) Inventor: Jerry R. Olson, St. Paul, MN (US)

Correspondence Address: BRIGGS AND MORGAN, P.A., 2400 IDS CENTER, MINNEAPOLIS, MN, 55402, US

(21) Appl. No.: 10/358,826

(22) Filed: Feb. 4, 2003

(51) Int. Cl. B02C 13/282

(52) U.S. Cl. 241/189.1

(57) ABSTRACT

A more efficient hammermill is provided. The upper cutting plates located near the inlet at the top of the hammermill has a double radiused profile which increases the steepness of the angle between the hammer and the upper radiused segment of the cutting plate. As material is flung off the hammer, it impacts the more steeply angled upper radiused segment of the cutting plate. The upper radiused segment also provides a progressively tighter radius for the entering material and facilitates the finer reduction that occurs as a result of the closer clearance between the hammer tips and the lower radiused segment.

The axis of the rotor is offset generally vertically toward the inlet of the hammermill. This places the hammer tips closer to the top of the working chamber, resulting in enhanced particle reduction in the primary destruction zone, thus increasing capacity of the hammermill. Finally, a plurality of classification zones are provided defined by convex cutting plates and screens. Because of the vertically offset rotor, the clearance between the hammer tips and the screens is increased, allowing for a deceleration of particles flowing along the screens which increases the differential in speed between the hammers and the particles. The cutting plates extend into the grinding chamber thus reducing the tolerance between the surface of the cutting plate and the hammer tip resulting in disruption of particle flow, causing the particles to be flung upwardly into the path of the hammers where the impact force is made greater due to the slowed acceleration of the particles. The material that is not removed through the next screen encounters another cutting plate where the process is repeated.

### FIELD OF THE INVENTION

This invention relates generally to hammermills.

### BACKGROUND OF THE PRESENT INVENTION

Hammermills have long been used for grinding or comminution of materials. Typically hammermills consist of a rotor mounted inside a housing. A material inlet is generally located at the top of the housing with one or more material outlets located near the bottom of the housing. The rotor includes a drive shaft and rows of hammers which are normally flat steel blades or bars. A steel rod or pin pivotably connects the hammer to the rotor. The rotor is mounted inside a typically teardrop shaped enclosure, commonly known as a grinding or working chamber, which is comprised of a cutting plate mounted on either side of the material inlet for reversible hammermills. Reversible hammermills are capable of rotation in either direction, a feature which provides for increased life for the hammers, cutting plates and screen plates. The known cutting plates are comprised of a upper linear section connected with a convex radiused section and do not allow particles to escape.

Downstream of the cutting plate, the interior of the working chamber is defined by curved screen plates. The screen opening diameter is selected to match the desired particle size. Generally, material at or below an intended size limit exit the chamber through the screens while material above the size limit continue to be reduced by the rotating hammers.

Reduction efficiency is enhanced with the addition of one or more regrind chambers which are essentially small cavities extending outwardly from the grinding chamber located between two screens. The regrind chamber captures remaining material on its leading edge whereupon the pressure gradient resulting from the air flow within the working chamber immediately causes the material to be forced out of the regrind chamber and back into the path of the rotating hammers thus increasing the efficiency of the hammermill. Other known devices incorporate breaker bars mounted at the bottom of the chamber. The breaker bars simply interrupt the circular flow of material along the screen plates, causing the material to be deflected into the path of the hammers resulting in further reduction.

The typical configuration of reversible hammermills involves placement of the elements about a vertical axis of symmetry extending on either side of a plane that extends through the rotor axis. Superimposing the face of a clock on a cross-section of the device, the cutting plates typically extend from the one o'clock to the three o'clock and from the nine o'clock to the eleven o'clock positions. The positioning of the screen plates, breaker bars and regrind chamber(s) have typically been symmetrically positioned between the three o'clock and nine o'clock positions.

In operation, the material to be reduced is fed into the material inlet and is directed toward the rotating hammers. The material is initially impacted by the hammers, which may cause some material reduction. The material is then flung from the hammer face against the cutting plates resulting in a primary reduction of material. After the material impacts the cutting plate, from which there is typically no outlet, the material is either flung back toward the rotating hammers or continues downstream between the hammer tip and the cutting plate until the screen plates are reached.

Ultimately, the particles encounter the openings of the screen plates. Here, the particles that are small enough begin to exit through the screen openings. The remaining particles impact the leading edge of the screen openings and are deflected up into the hammers' path. The rotating hammers continue to pulverize the material downstream of the cutting plate, moving it along the surface of the screens which define the circumference of the working chamber, causing gradual diminution of the material. Ultimately, the material is ground finely enough to permit it to flow out through the screens.

While the symmetrical reversible hammermill design as described above has been generally accepted and is widely used, there is a constant need and desire to increase the efficiency of the devices. Increasing efficiency will allow operation of the hammermill with decreased power consumption while increasing the capacity of the machine.

The present invention accomplishes these goals.

### SUMMARY OF THE INVENTION

A more efficient hammermill is provided. The increase in efficiency and capacity is obtained by three separate improvements. First, the upper cutting plates located near the inlet at the top of the hammermill has a double radiused profile. This allows for additional material loading and increases the steepness of the angle between the hammer and the upper radiused segment of the cutting plate. Thus, as the material is flung off the hammer, it impacts the more steeply angled upper radiused segment of the cutting plate. This, in turn, increases the force with which the material strikes the cutting plate. In addition, the steepness of the angle of the material's path as it is deflected from the cutting plate back into the hammers' path is increased, causing the collision between the deflected material and the rotating hammer to be more violent. Finally, the upper radiused segment provides a progressively tighter radius for the entering material and facilitates the finer reduction that occurs as a result of the closer clearance between the hammer tips and the lower radiused segment. The result is an enhanced particle reduction in the primary destruction zone, as defined by the double-radiused cutting plates, and an increase in capacity without additional power consumption.

A second aspect of the invention is that the axis of the rotor is offset generally vertically toward the inlet of the hammermill. This places the hammer tips closer to the top of the working chamber, resulting in enhanced particle reduction in the primary destruction zone, thus increasing capacity of the hammermill.

Third, a plurality of cutting and screening zones are provided, downstream of the primary cutting zone, preferably four screening zones are provided, each being separated by convex cutting plates. Because of the vertically offset rotor, the clearance between the hammer tips and the screens is increased, allowing for a deceleration of particles flowing along the screens which increases the differential in speed between the hammers and the particles. The cutting plates extend into the grinding chamber thus reducing the tolerance between the surface of the cutting plate and the hammer tip resulting in disruption of particle flow, causing the particles to be flung upwardly into the path of the hammers where the impact force is made greater due to the slowed acceleration of the particles. The material that is not removed through the next screen encounters another cutting plate where the process is repeated. Such a configuration greatly increases the reduction capacity of the hammermill. A further gain in efficiency is obtained by using screens with successively increased slot size to virtually ensure that no material is left following one cycle through the working chamber. If desired, the variation of screen hole sizing may be used to allow for particle gradation and collection.

An object and advantage of the invention is to provide a hammermill with increased comminutive efficiency.

Another object and advantage of the invention is to increase particle destruction in the primary destruction zone by providing at least one upper cutting plate that has more than one radius.

A further object and advantage of the invention is to increase particle destruction in the primary destruction zone and enhanced egress of particles via screens by offsetting the axis of the rotor generally toward the inlet of the hammermill.

Another object and advantage of the invention is to increase the comminutive efficiency by providing a plurality of replaceable convex cutting plates, the cutting plates having variable hole or slot patterns and sizes, disposed between the screens of the hammermill, to disrupt the flow, and slow the speed of, particles, thus increasing the force with which the particles impact the rotating hammers.

Yet another object and advantage of the invention is to increase the comminutive efficiency by providing replaceable screens with successively increased hole sizes, the screens being disposed between convex cutting plates.

The foregoing objects and advantages of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a sectional view of the hammermill.

FIG. 2 is a broken away view of the material inlet and working chamber.

FIG. 3 is broken away view of one double-radiused upper cutting plate and indicates the offset rotor position.

FIG. 4 shows one embodiment of the double-radiused upper cutting plate slots.

FIG. 5 shows one embodiment of convex cutting plate slots.

### DETAILED DESCRIPTION OF THE INVENTION

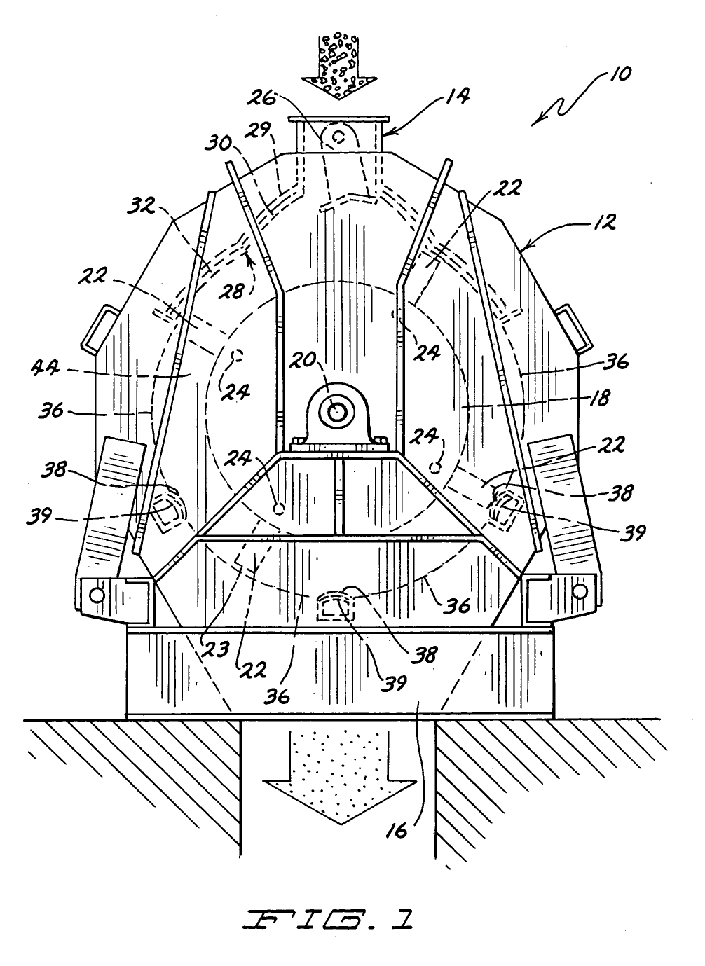

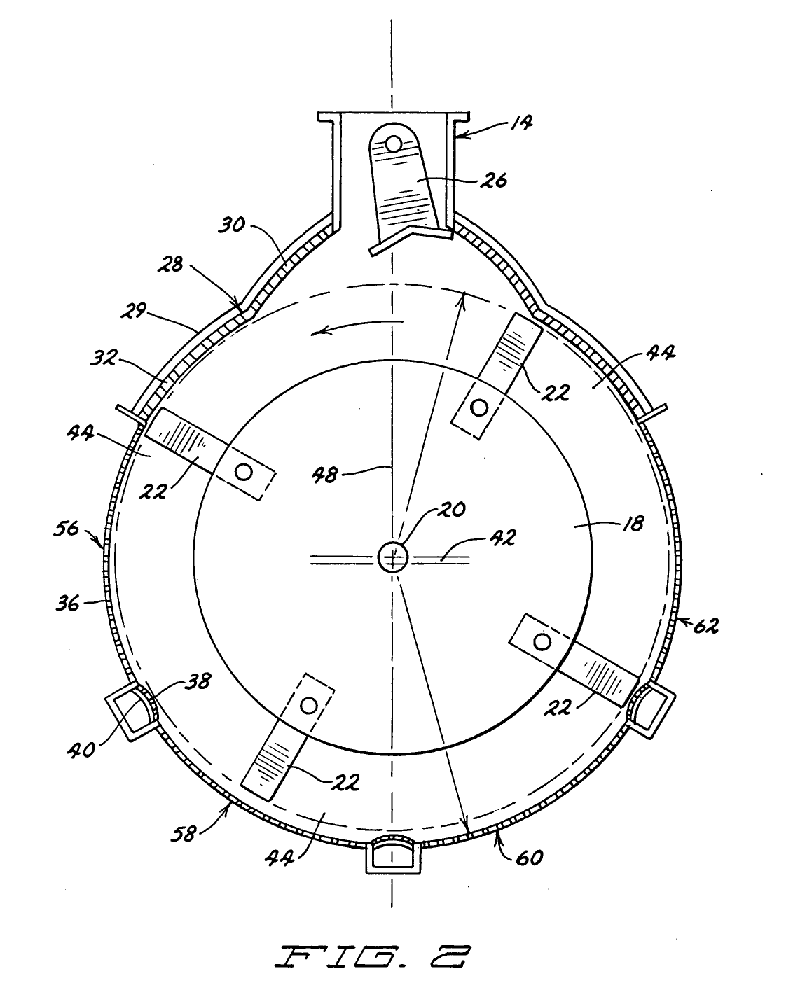

With reference to the accompanying figures, there is provided a hammermill (10) having improved comminutive efficiency. FIG. 1 shows a hammermill (10) including a housing (12), preferably made of metal, with a material inlet (14) located through the top of the housing and a ground particle discharge (16) at the bottom of the housing. There is further provided a rotor (18) that is mounted on a driven shaft (20) that rotates about an axis of rotation. Hammers (22) are pivotably mounted with pins (24) in rows on the rotor (18). In the preferred embodiment, the hammermill (10) is reversible, with the drive shaft (20) being capable of rotating the rotor (18) in either direction. A reversible gate (26) mounted within the inlet (14) prevents the material from being driven upwardly through the inlet (14) as a result of impact with the hammers (22). FIGS. 1 and 2 show the reversible gate (26) in position to prevent material loss assuming the rotor (18) and hammers (22) are rotating in a counterclockwise fashion.

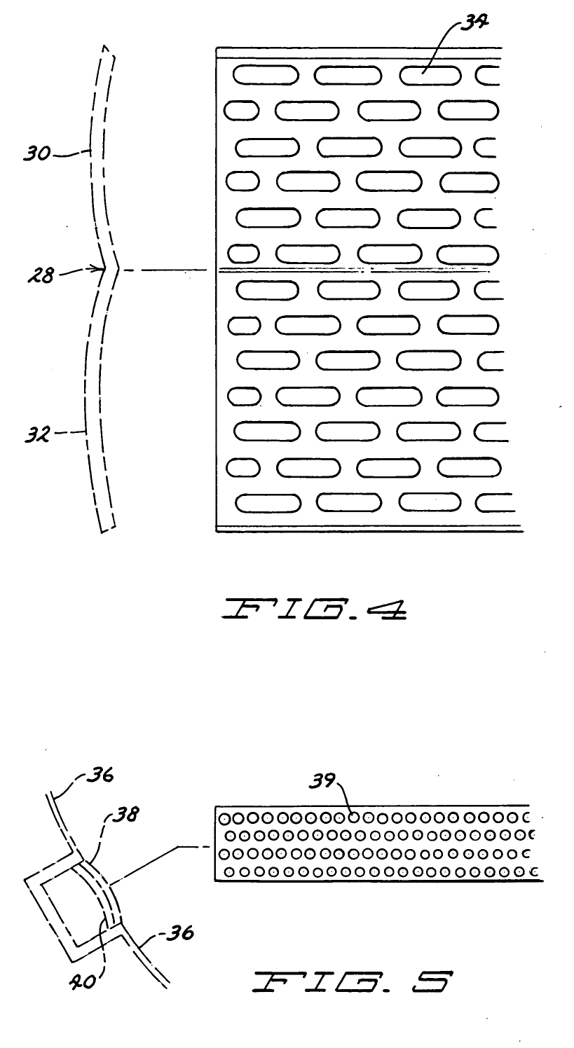

Downstream of the inlet (14), that is, in the direction of hammer rotation and material flow, two upper cutting plates (28) are symmetrically mounted adjacent the inlet (14), each having an upper radiused segment (30) and a lower radiused segment (32). FIG. 2 shows the upper cutting plates (28) mounted on a solid backing plate (29) which prevents the material to be comminuted from escaping at that point in the process. The upper radiused segment (30) allows sufficient clearance to maintain the feed at maximum capacity while at the same time reducing the circumference dimension required to force the material flow into the second radiused segment (32) of the upper cutting plate (28) where the clearance between the plate (28) and the hammer tips (23) is much closer. Thus, the fed material is subjected to a first stage pre-break reduction to facilitate feeding into the closer clearance of the second radiused segment (32). Once in contact with the second radiused segment (32), the material is subjected to closer hammer tip (32) tolerances to produce a second stage finer reduction. FIG. 4 shows one embodiment for the upper cutting plate slot sizes (34) and pattern. It will be appreciated by those skilled in the art that a number of equivalent combinations of slot size (34) and pattern present themselves depending on the material to be comminuted.

Downstream of the upper cutting plates (28), a plurality of curved screen plates (36) are joined together at junctures. FIG. 2 illustrates one embodiment of the invention wherein the junctures are comprised of convex cutting plates (38) that are mounted on solid backing plates (40). The convex cutting plates (38) create impact points for the material to be comminuted, interrupting the rotational flow along the screen plates (36) and causing the material to impact the rotating hammers (22) as well as enhancing the egress of appropriately reduced particles through the screen plate (36) downstream of the convex cutting plate (38).

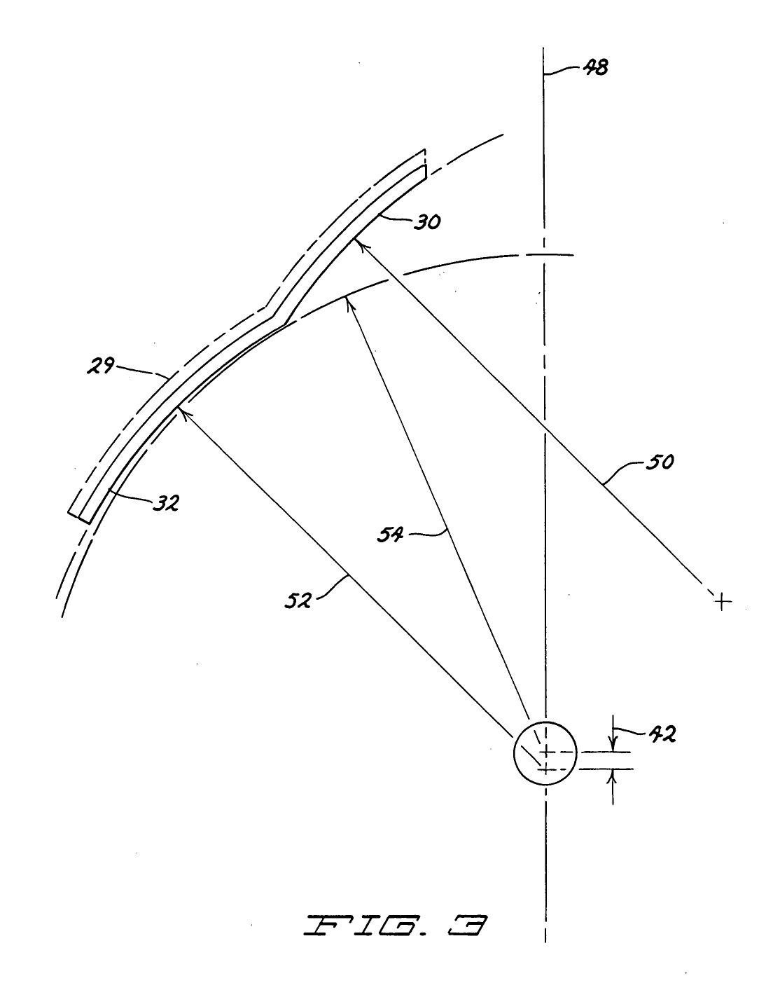

The rotor (18) is biased substantially vertically toward the material inlet (14) of the hammermill (10). To accomplish this bias (42), illustrated in FIGS. 2 and 3, the rotor drive shaft (20) is elevated toward the inlet (14), reducing the clearances between the hammer tips (23) and the upper cutting plates (28) and increasing the clearance between the hammer tip (23) and the curved screen plates (36). The clearance reduction between the hammer tips (23) and the upper cutting plates (28) produces an even finer degree of reduction than the upper double-radiused cutting plate (28) alone. The increased clearance between the hammer tips (23) and the screens (36) creates a deceleration zone in which appropriately reduced particles can more readily escape rotation through the screen slots (46), thus increasing the efficiency of the hammermill (10).

FIGS. 1 and 2 illustrate a working chamber (44) within the housing (12) that is defined by the space between the upper cutting plates (28), screens (36) and convex cutting plates (38), and the rotor (18). FIG. 2 shows the upper cutting plates (28), curved screen plates (36) and convex cutting plates (38) arranged in the preferred embodiment about a vertical plane of symmetry (48) that cuts through the axis of rotation of the rotor (18) to allow for comminuting in either rotational direction. Thus, viewing the working chamber (44) with the face of a clock superimposed thereon, preferably the upper cutting plates (28) extend from the one o'clock to the three o'clock and from the nine o'clock to the eleven o'clock positions respectively. The screen plates (36) and convex cutting plates (38) are then preferably symmetrically distributed about the vertical plane of symmetry (48) and between the three o'clock and nine o'clock positions.

The convex cutting plates (38) extend into the working chamber (44), creating regions of reduced clearance between the hammer tips (23) and the convex cutting plates (38). Preferably, there are three convex cutting plates (38) and four curved screen plates (36) creating four classification zones for sizing particles. Screen slot sizes (46) and patterns can be selected to maximize comminutive efficiency as well as classify particles based on size.

Operation of the preferred embodiment may now be described.

Material to be comminuted is fed into the material inlet (14) of the hammermill (10). In the preferred embodiment, the hammermill (10) is reversible and the comminuting elements are distributed symmetrically about a vertical plane of symmetry (48) that cuts through the axis of rotation of the rotor (18) to allow for two-way rotation of the rotor (18) and hammers (22). Assuming counterclockwise rotation of the rotor (18) and hammers (22), the inlet gate (14) is closed as shown in FIGS. 1 and 2. The fed material exits the inlet (14) and enters the working chamber (44) where it is impacted by the rotating hammers (22) and flung initially against the upper radiused segment (30) of the upper cutting plate (28). As seen in FIG. 3, the progressively tighter radius (50) of the upper radiused segment (30) in turn results in a progressively tighter clearance between the upper radiused segment of the cutting plate (30) and the hammer tips (23), subjecting the material to a first stage pre-break reduction. FIGS. 2 and 3 illustrate this concept. The reduced material then continues downstream in the direction of hammer (22) rotation to encounter the closer tolerance of the lower radiused segment of the cutting plate (32) where a second stage finer reduction occurs. The efficiency of the reduction by the upper cutting plates (28) is enhanced by the vertically offset rotor (18) which reduces the clearance between the hammer tips (23) and the upper radiused segment (30) and lower radiused segment of the upper cutting plate (32).

After leaving the upper cutting plates (28), the particles continue downstream to a curved screen (36) where particles that are appropriately sized may escape the rotation of the hammers (22) by exiting through screen slots (46). The particles are generally accelerated in the direction of hammer rotation. This acceleration works to lessen the speed difference between the hammer (22) and the particles, thus lessening the impact force and decreasing the comminuting efficiency as particles accelerate.

The invention provides for convex cutting plates (38) mounted on solid backing plates (40) at each screen juncture. The convex cutting plates (38) work in two ways to improve the comminutive efficiency of the hammermill (10). First, the material impacts the cutting plate slot (39) pattern, resulting in some reduction. It will be appreciated by those skilled in the art that the cutting slot pattern and slot size may be altered in a variety of ways to enhance reduction efficiencies, dependent on the type of material being comminuted. One embodiment of the cutting plate slot size (39) and pattern is shown in FIG. 5. Second, due to the high rate of speed at impaction with the convex cutting plate (38), the particle flow along the screen wall is interrupted. The particles are slowed and flung upward and into the path of the rotating hammers (22), thus increasing the difference between the particle speed and hammer speed resulting in increased reduction efficiency. Appropriately sized particles are then removed when encountering the next screen (36) located downstream of the convex cutting plate (38).

In addition to increasing the reduction efficiencies by tightening the tolerances between the hammer tips (23) and the upper cutting plates (28), the vertically offset rotor (18) improves the comminutive efficiency in the region of the curved screens (36) and convex cutting plates (38). FIG. 2 illustrates increased clearance between the hammer tips (23) and the screens (36) accomplished by the vertically biased drive shaft (20) and rotor (18), thus providing for an additional deceleration of the particles as they flow along the screens (36). Thus, appropriately sized particles may exit more readily through the screen slots (46). The deceleration also increases the speed differential between the rotating hammers (22) and the particles thus increasing the impact force when the particles are flung upwardly after encountering the convex cutting plates (38).

The preferred embodiment uses curved screen plates (36) following the upper cutting plates (28) or convex cutting plates (38) to accelerate exit of sized particles theroughout each rotation. The comminutive efficiency can be enhanced by varying the size and/or pattern of the screen holes (46) in each classification zone by simply replacing one screen plate (36) with another screen plate (36) with different slot sizes or pattern. For example, successively larger slot sizes as the material moves from classification zone 1 (56) to classification zone 2 (58) to classification zone 3 (60) to classification zone 4 (62) is known to result in an increase in comminutive efficiency by ensuring that virtually no material remains following one cycle around the working chamber (44). Another variable that may be used to enhance efficiency is modification of the convex cutting plate slots (38). Those skilled in the art will appreciate the numbers of combinations available to enhance such efficiencies using the present invention.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A comminuting assembly for a hammermill, comprising:
a) a housing defining an inlet and a working chamber, the inlet communicating with the working chamber to receive material to be comminuted;
b) a rotor rotatably mounted within the housing about an axis of rotation;
c) a plurality of hammers attached to the rotor;
d) at least one screen plate mounted about the rotor;
e) at least one upper cutting plate having an upper radiused segment to subject material to be comminuted to a first stage reduction and a lower radiused segment to subject the material to be comminuted to a second stage finer reduction.

2. The comminuting assembly of claim 1, further comprising a plurality of screen plates, the screen plates separated by junctures.

3. The comminuting assembly of claim 1, further comprising a plurality of screen plates, the screen plates separated by cutting plates.

4. The comminuting assembly of claim 1, further comprising a plurality of screen plates, the screen plates separated by convex cutting plates.

5. The comminuting assembly of claim 1, further comprising two upper cutting plates, the upper cutting plates secured in close proximity to the inlet, in a substantially symmetrical fashion about the inlet.

6. The comminuting assembly of claim 1, wherein the comminuting assembly further comprises a vertical plane cutting through the axis of rotation of the rotor, the upper cutting plates, screen plates and convex cutting plates being arranged symmetrically about the vertical plane cutting through the rotor axis of rotation.

7. The comminuting assembly of claim 6 wherein the axis of rotation of the rotor is biased substantially toward the inlet.

8. A comminuting assembly for a hammermill, comprising:
a) a housing defining an inlet and a working chamber, the inlet communicating with the working chamber to receive material to be comminuted;
b) a rotor rotatably mounted within the housing about an axis of rotation;
c) a plurality of hammers attached to the rotor;
d) a plurality of screen plates mounted about the rotor; and
d) at least one convex cutting plate disposed between adjacent screen plates.

9. The comminuting assembly of claim 8, further comprising at least one upper cutting plate, the upper cutting plate having an upper radiused segment to subject material to be comminuted to a first stage reduction and a lower radiused segment to subject the material to be comminuted to a second stage finer reduction.

10. The comminuting assembly of claim 9, further comprising two upper cutting plates, the upper cutting plates secured in close proximity to the inlet, in a substantially symmetrical fashion about the inlet.

11. The comminuting assembly of claim 10, wherein the assembly is further defined by a vertical plane intersecting the axis of rotation of the rotor, and where the upper cutting plates, screen plates and convex cutting plates are arranged symmetrically about the vertical plane.

12. The comminuting assembly of claim 8 wherein the axis of rotation of the rotor is biased toward the inlet.

13. A comminuting assembly for a hammermill, comprising:
a) a housing defining an inlet and a working chamber, the inlet communicating with the working chamber to receive material to be comminuted;
b) a rotor rotatably mounted within the housing about an axis of rotation, the axis of rotation being biased toward the inlet;
c) a plurality of hammers attached to the rotor;
d) at least one screen plate mounted about the rotor, and
e) at least one upper cutting plate, the upper cutting plate mounted in close proximity to the inlet.

14. The comminuting assembly of claim 13, further comprising a plurality of screen plates, the screen plates separated by junctures.

15. The comminuting assembly of claim 13, further comprising a plurality of screen plates, the screen plates separated by convex cutting plates.

16. The comminuting assembly of claim 13, wherein the at least one upper cutting plate further comprises an upper radiused segment to subject material to a first stage reduction and a lower radiused segment to subject the material to be comminuted to a second stage finer reduction.

17. The comminuting assembly of claim 16, further comprising two upper cutting plates secured in close proximity to the inlet and symmetrically about the inlet.

18. The comminuting assembly of claim 17, further comprising arranging the upper cutting plates, the convex cutting plates and screen plates symmetrically about the vertical plane cutting through the rotor.

19. A comminuting assembly for a hammermill, comprising:
a) a housing defining an inlet and a working chamber, the inlet communicating with the working chamber to receive material to be comminuted;
b) a rotor rotatably mounted within the housing about an axis of rotation, the axis of rotation being biased toward the inlet;
c) a plurality of hammers attached to the rotor;
d) a plurality of screen plates mounted about the rotor;
e) a plurality of convex cutting plates, the cutting plates interposed between adjacent screen plates; and
f) two upper cutting plates, the upper cutting plates having an upper radiused segment to subject material to be comminuted to a first stage reduction and a lower radiused segment to subject the material to be comminuted to a second stage reduction, the upper cutting plates secured in close proximity to the inlet, in a substantially symmetrical fashion about the inlet.
